(19) United States
(12) Patent Application Publication
(10) Pub. No.: US 2020/0023670 A1
(43) Pub. Date: Jan. 23, 2020

(54) Stylus Holder

(71) Applicant: Samsonite IP Holdings S.ar.l., Luxembourg (LU)

(72) Inventors: Bryan Lee Hynecek, Redwood City, CA (US); Christopher William Ledesma, Arcadia, CA (US); Kenneth Wang, San Jose, CA (US); Minna Chong, Oakland, CA (US)

(73) Assignee: Samsonite IP Holdings S.ar.l., Luxembourg (LU)

(21) Appl. No.: 16/039,075

(22) Filed: Jul. 18, 2018

(51) Int. Cl. B43K 31/00; G06F 3/0354

(52) U.S. Cl. CPC B43K 31/00; G06F 3/03545

(57) ABSTRACT

A holder for a stylus for a mobile device, including a body, an extending portion, and a first attachment feature. The body includes a tip end at one end and an opening at an opposite end. The tip end is configured to cover a tip of the stylus when in the holder. The opening being configured to accept the stylus into the body. The extending portion includes an extending end that extends from the opening in a direction away from the body, and a cap portion at cap end of the arm opposite the extending end of the arm. The cap portion is configured to cover at least a portion of a cap end of the stylus opposite the tip of the stylus. The first attachment feature is configured to removably mate or connect with a corresponding attachment feature of a mobile device or a mobile device case.

### FIELD OF THE INVENTION

The present invention relates to a holder for a stylus, such as the Apple Pencil™. The holder is preferably manufactured as a single piece made from a single material or material mixture or combination. The holder also preferably includes one or more attachment features so that the holder can be removably attached or connected to a mobile device case, such as a folio case for a tablet computer or the like.

Various stylus holders have been designed to allow a user to attach a stylus to a mobile electronic device or mobile electronic device case. For example, stylus holders have been designed as a clip that snaps around or an elastic band that wraps around the diameter of a stylus. Such clips or elastic bands are typically permanently attached to a mobile device case or are provided with a means, such as an adhesive strip, for permanently attaching the holder to a mobile device or mobile device case. But such clips and elastic bands do not cover either the bottom tip end of the stylus or the opposite top cap end, leaving these ends of the stylus exposed and unprotected from being scratched or otherwise damaged in an impact event such as a fall or drop.

Stylus holders have also been designed as sleeves into which a stylus is slid. These sleeves typically cover a majority of the front, back, left, and right sides (i.e., the cylindrical periphery surfaces extending from the bottom tip end to the opposite top cap end) of the stylus, thereby protecting a majority of the side surfaces from scratching. Such sleeves also often cover the bottom tip end of the stylus, thereby additionally protecting the bottom tip end of the stylus from scratching. But such sleeves are frequently made of cloth, leather, or some other floppy non-rigid material, and so do not protect the stylus from breaking, bending, or denting due to an impact event like a fall or drop. Such sleeves also do not cover the top cap end opposite the bottom tip end of the stylus, leaving this end of the stylus exposed and unprotected from being scratched or otherwise damaged in an impact event such as a fall or drop.

### SUMMARY OF THE INVENTION

As such, it is desirable to provide a new holder for a stylus that is rigid or semi-rigid and sufficiently thick to protect a stylus from both scratches and from breaking, bending, or denting due to an impact event like a fall or drop. It is also desirable to provide such a new rigid holder with portions that cover a majority of the stylus, including the bottom tip end and the top cap end. And it is further desirable to provide the new holder with an attachment feature so that the holder can be removably attached or connected to a mobile device case, such as a folio case for a tablet computer or the like.

According to the present invention there is therefore provided a holder for a stylus as described by way of example below and in the accompanying claims.

In one embodiment of the invention there is provided a holder (1) for a stylus (100) for a mobile device, including a body (21), an extending portion (24), and a first attachment feature (26,27). The body (21) includes a tip end (22) at one end and an opening (23) at an opposite end. The tip end (22) is configured to cover a tip of the stylus (100) when in the holder. The opening (23) being configured to accept the stylus (100) into the body (21). The extending portion (24) includes an extending end that extends from the opening (23) in a direction away from the body (21), and a cap portion (25) at cap end of the arm opposite the extending end of the arm. The cap portion (25) is configured to cover at least a portion of a cap end of the stylus (100) opposite the tip of the stylus (100). The first attachment feature (26,27) is configured to removably mate or connect with a corresponding attachment feature of a mobile device or a mobile device case.

In another embodiment, the cap portion (25) is configured to snap onto at least portion of the cap end of the stylus (100).

In yet another embodiment, the first attachment feature (26,27) is a retaining feature (26) configured to engage with and retain an engaging portion of the mobile device or mobile device case to removably connect the holder (1) to the mobile device or mobile device case.

In a further embodiment, the retaining feature (26) includes a groove, channel, recess, indentation, or hole.

In a further embodiment, the retaining feature (26) is configured to snap onto and off of the engaging portion of the mobile device or mobile device case.

In yet a further embodiment, the retaining feature (26) is configured to snap onto and off of a protrusion, bulge, lump, nub, tab, or peg of the engaging portion of the mobile device or mobile device case.

In another embodiment, the holder (1) further includes a second attachment feature (26,27) configured to removably mate or connect with a corresponding attachment feature of a mobile device or a mobile device case.

In yet another embodiment, the first attachment feature (26,27) is an engaging feature (27) configured to engage with and be retained by a retaining portion of the mobile device or mobile device case to removably connect the holder (1) to the mobile device or mobile device case.

In a further embodiment, the second attachment feature (26,27) is an engaging feature (27) configured to engage with and be retained by a retaining portion of the mobile device or mobile device case to removably connect the holder (1) to the mobile device or mobile device case.

In yet a further embodiment, the engaging feature (27) includes a protrusion, bulge, lump, nub, tab, or peg.

In another embodiment, the engaging feature (27) is configured to snap into and out of the retaining portion of the mobile device or mobile device case.

In yet another embodiment, the engaging feature (27) is configured to snap into and out of a groove, channel, recess, indentation, or hole of the retaining portion of the mobile device or mobile device case.

In a further embodiment, the holder (1) is manufactured as a single piece made from a single material or material mixture or combination.

In yet a further embodiment, the holder (1) is made from at least one material selected from the group consisting of an elastomeric material, rubber, silicone, thermoplastic elastomers (“TPEs”), thermoplastic polyurethane (“TPU”), polyolefins, polypropylene, polycarbonate, polyvinyl chloride acetate (“PVCA”), a similar plastic, and any combination thereof.

In another embodiment, the cap portion (25) is configured to cover 25% to 100% of the cap end of the stylus (100) when in the holder (1).

In yet another embodiment, the holder (1) has a thickness dimension D_{T}, measured as a wall thickness of the body (21), of 1.0 to 5.5 mm.

In a further embodiment, the holder (1) is configured to cover at least 50% of the surface area of the stylus (100) when arranged in the holder (1).

It is noted that the features of the above-described embodiments are not exclusive to each other, and that any one of the above embodiments/features can be combined with one or more of the other embodiments/features to arrive at further embodiments.

The inventive holder can be designed to fit a variety of styluses and to attach toi a variety of mobile devices and cases—such as smartphones, other portable electronic devices, and cases therefor.

### BRIEF DESCRIPTION OF THE DRAWINGS

FIG. 1 is a front upper-right perspective view of the holder in accordance with an embodiment of the invention.

FIG. 2 is a front upper-right perspective view of the holder in accordance with an embodiment of the invention with a stylus placed in the holder.

FIG. 3 is a front upper-left perspective view of the holder in accordance with an embodiment of the invention with a stylus placed in the holder.

FIG. 4 is a front-right side view of the holder in accordance with an embodiment of the invention with a stylus placed in the holder.

FIG. 5 is a rear upper-left perspective view of the holder in accordance with an embodiment of the invention with a stylus placed in the holder.

FIG. 6 is a front side view of the holder in accordance with an embodiment of the invention.

FIG. 7 is a rear side view of the holder in accordance with an embodiment of the invention.

FIG. 8 is a front side view of the holder in accordance with an embodiment of the invention.

FIG. 9 is an enlarged view of the area indicated by the broken-line box in FIG. 8.

FIG. 10 is a left side view of the holder in accordance with an embodiment of the invention.

FIG. 11 is a right side view of the holder in accordance with an embodiment of the invention.

FIG. 12 is an enlarged view of the area indicated by the broken-line box in FIG. 11.

FIG. 13 is a rear side view of the holder in accordance with an embodiment of the invention.

FIG. 14 is an enlarged view of the area indicated by the broken-line box in FIG. 13.

FIG. 15 is an upper side view of the holder in accordance with an embodiment of the invention.

FIG. 16 is an enlarged view of FIG. 15.

FIG. 17 is an upper side view of the holder in accordance with an embodiment of the invention.

FIG. 18 is an enlarged view of FIG. 17.

FIG. 19 is a front upper-left perspective view of the holder in accordance with an embodiment of the invention.

FIG. 20 is a rear upper-right perspective view of the holder in accordance with an embodiment of the invention.

FIG. 21 is a cross-sectional view of the holder in accordance with an embodiment of the invention.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments. It is noted that any numerical ranges disclosed herein are included to individually disclose every sub-range and number, both whole integer and partial fraction, within the disclosed range. For example, a disclosed range of 1-100 is intended to individually disclose 20-90, 40-80, 30.5-50.2, 20, 67.3, 84.512924, and every other range and number that falls within the recited range.

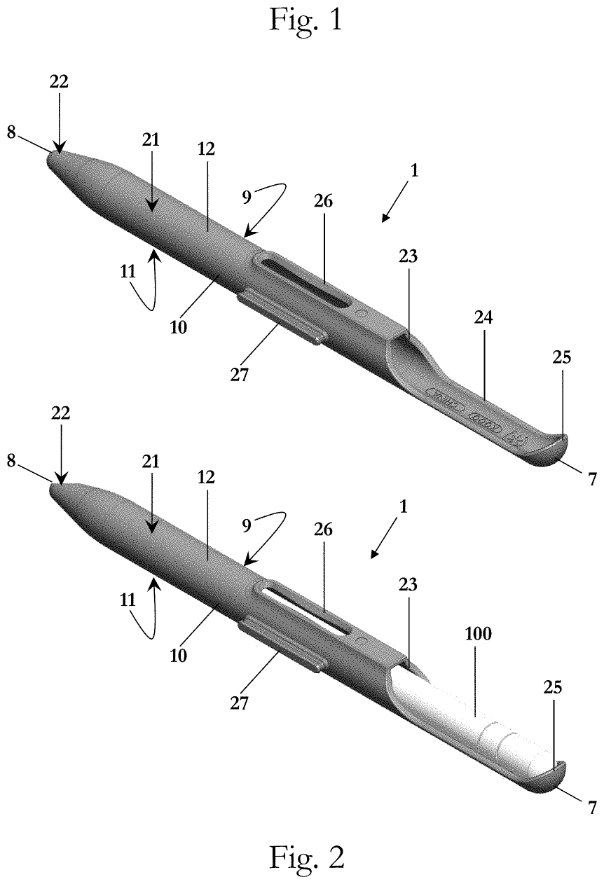

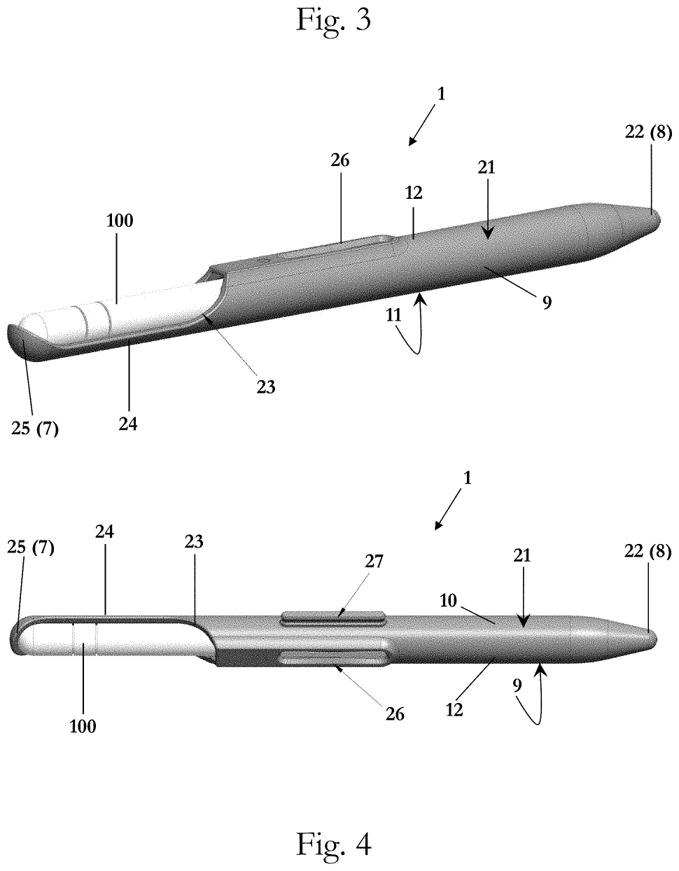

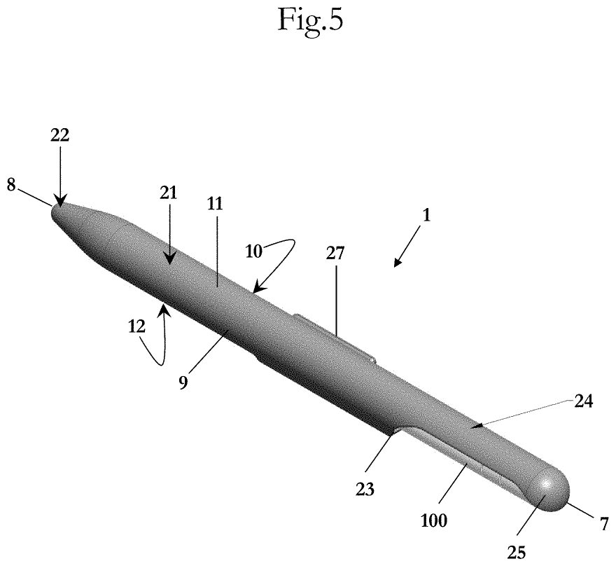

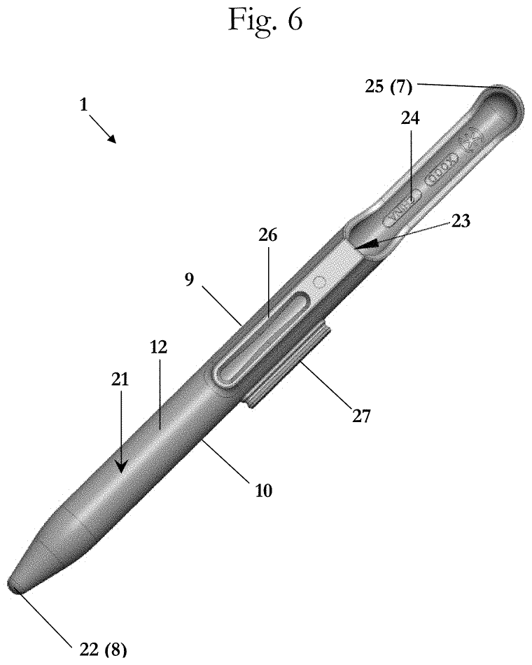

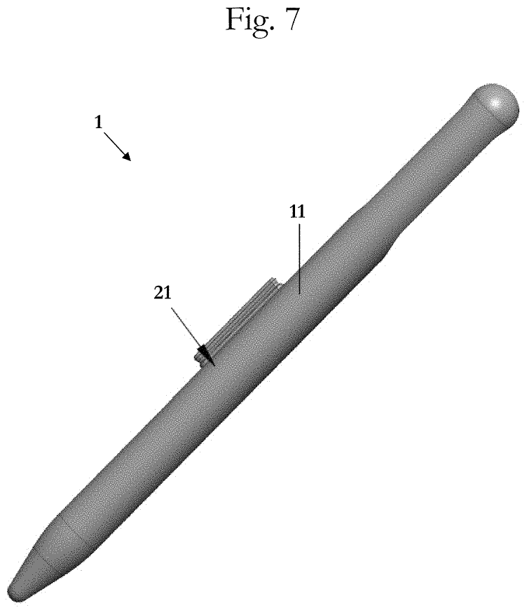

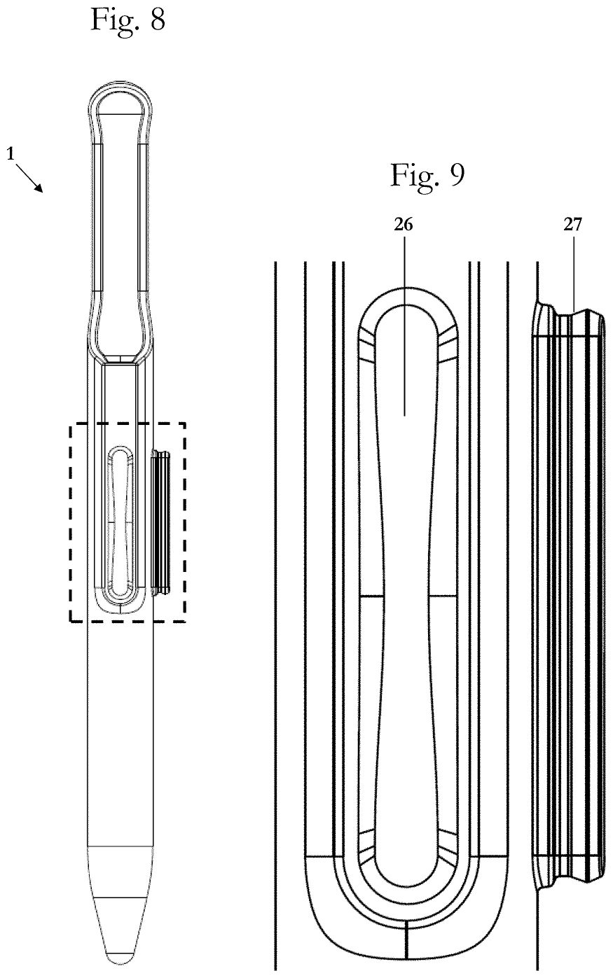

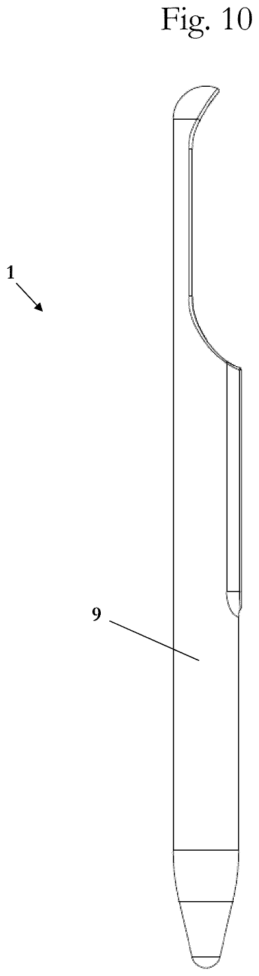

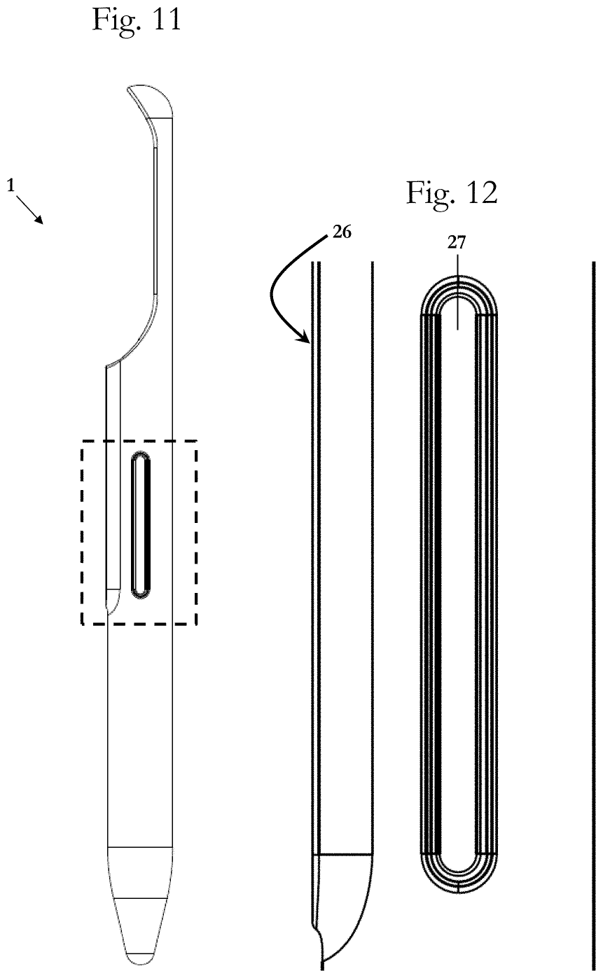

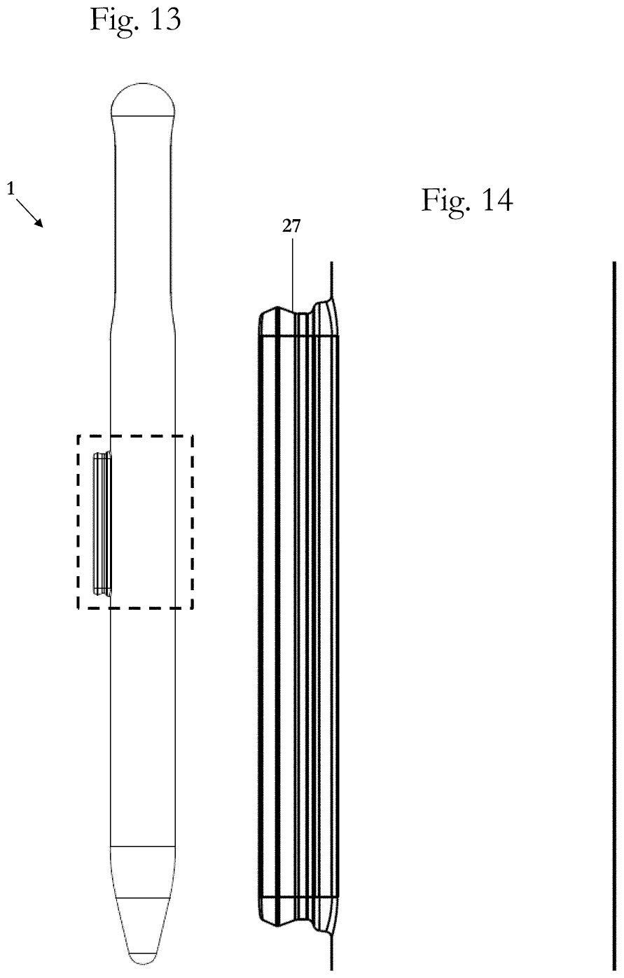

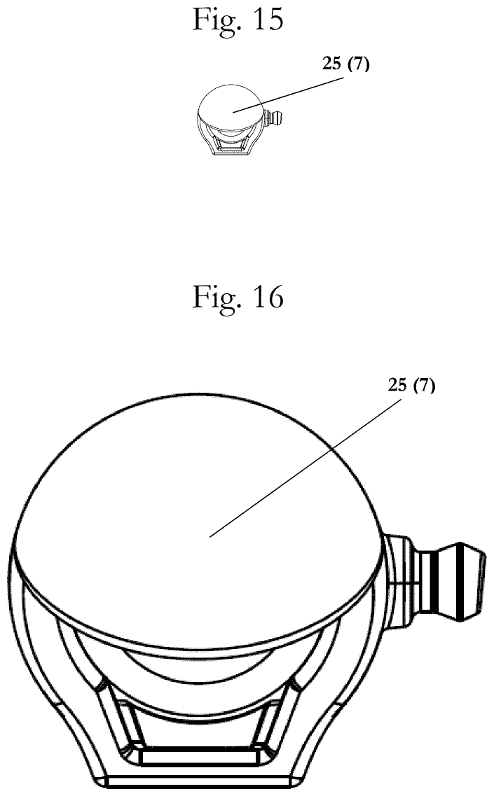

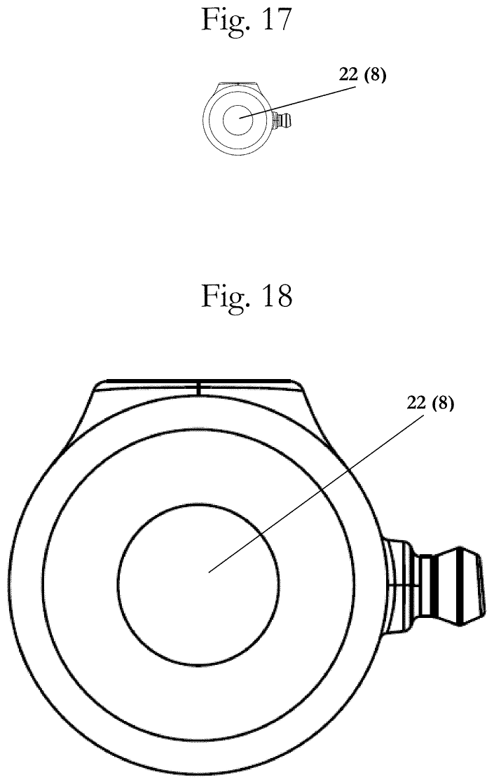

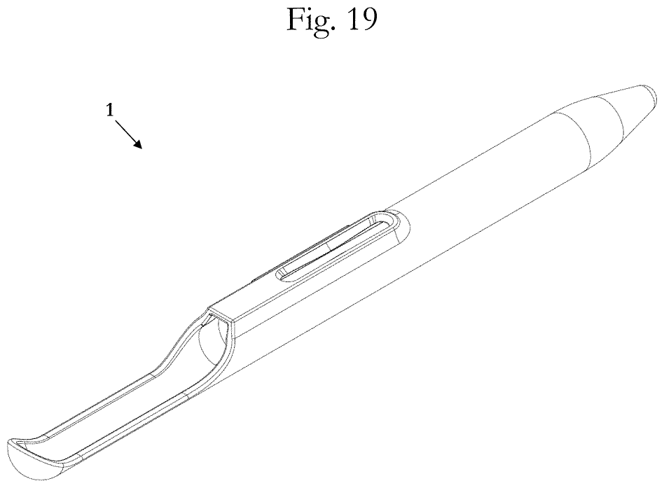

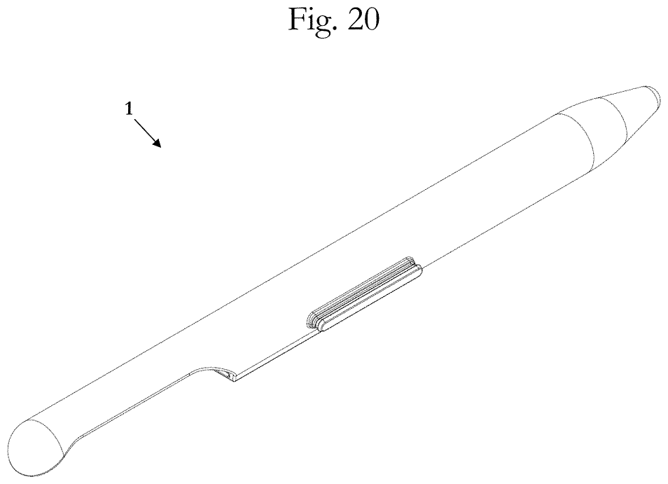

FIGS. 1-20 show various views of the holder 1 in accordance with an embodiment of the invention. The holder 1 has an upper side 7, a lower side 8, a left side 9, a right side 10, rear side 11, and a front side 12. Preferably the holder is tube-shaped or cylindrically shaped as shown in FIGS. 1-20.

The holder 1 includes a body 21, which starts at a tip end 22 at the lower side 8 and extends to an opening 23 for inserting a stylus 100 into the body 21. An extending portion or arm 24 extends from the opening 23 in a direction away from the body 21. The arm 24 includes a cap portion 25. The tip end 22 is configured to cover and securely hold the tip of a stylus 100 when in the holder, and the cap portion 25 is configured to cover a cap end of the stylus 100 (opposite to the tip)—for example, the magnetic cap that covers the charging plug on an Apple Pencil™. In this manner, the holder 1 can securely hold both ends of a stylus 100 to prevent it from accidentally slipping out of the holder 1. Preferably, the cap portion 25 is configured to snap around at least portion of the cap end of a stylus 100. In addition, the cap portion 25 preferably is configured to cover 25% to 100% of the cap end of a stylus 100 when in the holder 1, more preferably 50% to 100%, even more preferably 75% to 100%. In one embodiment, the cap portion 25 is configured to cover 50% to 75% of the cap end of a stylus 100 when in the holder 1 to make it easier for a user to remove the stylus 100 from the holder 1 while still securely retaining it in the holder 1 and preventing it from accidentally slipping out unintentionally. In another embodiment, the cap portion 25 is configured to cover 25% to 50% of the cap end of a stylus 100 when in the holder 1.

In one embodiment, the body 21 also includes at least one attachment feature so that the holder can be removably attached or connected to a mobile device case, such as a folio case for a tablet computer or the like. For example, such an attachment feature can be formed by a retaining feature 26 that engages with and retains an engaging portion of the mobile device or mobile device case to securely, yet removably, connect the holder 1 to the mobile device or case. Examples of such a retaining feature 26 include a groove, channel, recess, indentation, hole, or the like. In one embodiment, the retaining feature 26 may be configured to snap onto and off of a mechanical feature—such as a protrusion, bulge, lump, nub, tab, peg, or the like—as the engaging portion of the mobile device or mobile device case. In this way, the engaging portion of the mobile device or case fits within and engages with the retaining feature 26 so that the retaining feature 26 retains the engaging portion to securely, yet removably, connect the holder 1 to the mobile device or mobile device case.

As another example, an attachment feature can be formed by an engaging feature 27 that engages with and is retained by a retaining portion of the mobile device or mobile device case to securely, yet removably, connect the holder 1 to the mobile device or mobile device case. Examples of such an engaging feature 27 include a protrusion, bulge, lump, nub, tab, peg, or the like.

In one embodiment, the engaging feature 27 may be configured to snap into and out of a mechanical feature—such as a groove, channel, recess, indentation, hole, or the like as the retaining portion of the mobile device or mobile device case. In this way, the engaging feature 27 fits within and engages with the retaining portion of the mobile device or case so that the engaging feature 27 is retained by the retaining portion of the mobile device or case to securely, yet removably, connect the holder 1 to the mobile device or mobile device case.

While the embodiment of the holder 1 shown in FIGS. 1-20 includes two attachment features—namely, both a retaining feature 26 and an engaging feature 27—the holder 1 may be configured with only one attachment feature. Similarly, the holder 1 may be configured with any combination of multiple attachment features—such as two or more retaining features 26, two or more engaging features 27, one retaining feature 26 and two or more engaging features 27, two or more retaining features 26 and one engaging feature 27, or any combination thereof. In addition, while certain examples of retaining features 26 and engaging features 27 are discussed above and shown in the drawings, any other suitable receiving and engaging features 26,27 intended to removably mate or connect with a corresponding attachment feature of a mobile device or mobile device case may be used.

The holder is preferably manufactured as a single piece—for example by injection molding—made from a single material or material mixture or combination. More preferably, the material or material mixture or combination includes an elastomeric material, rubber, silicone, thermoplastic elastomers (“TPEs”), thermoplastic polyurethane (“TPU”), polyolefins, polypropylene, polycarbonate, polyvinyl chloride acetate (“PVCA”), a similar plastic, or any combination thereof.

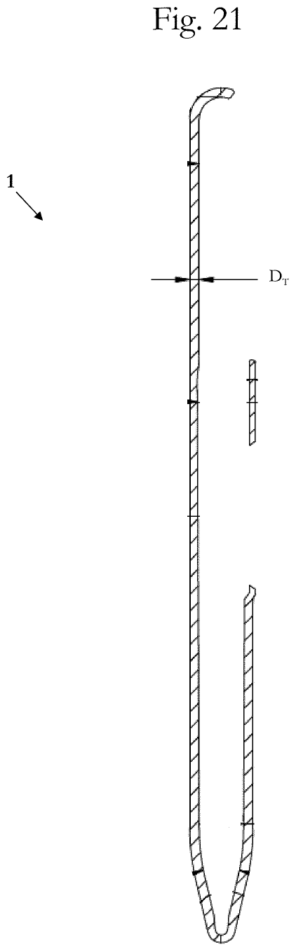

Preferably the holder 1 is rigid or semi-rigid and sufficiently thick to protect a stylus 100 from both scratches and from breaking, bending, or denting due to an impact event like a fall or drop. For example, as shown in FIG. 21, the holder 1 preferably has a thickness dimension D_{T} (measured as a wall thickness of the body 21, such as a difference between an internal annular diameter and an external annular diameter of the body 21) of 1.0 to 5.5 mm. More preferably the thickness is 1.3 to 4.0 mm, even more preferably the thickness is 1.8 mm to 2.8 mm, and most preferably the thickness is around 2.0 mm. The thickness dimension is determined based on the material or material mixture or combination of body 21 so that it is sufficiently thick to make the holder 1 rigid or semi-rigid, and additionally to provide some protection and or shock absorption to protect a stylus 100 when in the holder 1 from getting scratched or otherwise damaged in an impact event such as a fall or drop. In addition, the thickness dimension is sufficiently small so that the holder 1 does not add undue bulk to the stylus 100 or to the mobile device or mobile device case when the holder 1 is attached thereto.

In one embodiment, the holder 1 cover a majority of a stylus 100 when arranged in the holder 1. For example, the holder 1 can be configured to cover 50-100% of the surface area of a stylus 100 when arranged in the holder 1. Preferably the holder 1 is configured to cover 55-90% of the surface area of a stylus 100 when arranged in the holder 1, more preferably 60-85%, most preferably 66-80%.

It is noted that the terminology used above is for the purpose of reference only, and is not intended to be limiting. For example, terms such as “upper”, “lower”, “above”, “below”, “rightward”, “leftward”, “clockwise”, and “counterclockwise” refer to directions in the drawings to which reference is made. As another example, terms such as “inward” and “outward” may refer to directions toward and away from, respectively, the geometric center of the component described. As a further example, terms such as “front”, “rear”, “side”, “left side”, “right side”, “top”, “bottom”, “horizontal”, and “vertical” describe the orientation of portions of the component within a consistent but arbitrary frame of reference which is made clear by reference to the text and the associated drawings describing the component under discussion. Such terminology will include the words specifically mentioned above, derivatives thereof, and words of similar import.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

In addition, it is noted that citation or identification of any document in this application is not an admission that such document is available as prior art to the present invention.

1. A holder for a stylus for a mobile device, comprising:
a body comprising:
a tip end at one end, the tip end being configured to cover a tip of the stylus when in the holder; and
an opening at an opposite end, the opening being configured to accept the stylus into the body;
an extending portion comprising:
an extending end that extends from the opening in a direction away from the body; and
a cap portion at cap end of the arm opposite the extending end of the arm, the cap portion being configured to cover at least a portion of a cap end of the stylus opposite the tip of the stylus; and
a first attachment feature configured to removably mate or connect with a corresponding attachment feature of a mobile device or a mobile device case.

2. The holder for a stylus according to claim 1;
wherein the cap portion is configured to snap onto at least portion of the cap end of the stylus.

3. The holder for a stylus according to claim 1;
wherein the first attachment feature is a retaining feature configured to engage with and retain an engaging portion of the mobile device or mobile device case to removably connect the holder to the mobile device or mobile device case.

4. The holder for a stylus according to claim 3;
wherein the retaining feature comprises a groove, channel, recess, indentation, or hole.

5. The holder for a stylus according to claim 3;
wherein the retaining feature is configured to snap onto and off of the engaging portion of the mobile device or mobile device case.

6. The holder for a stylus according to claim 5;
wherein the retaining feature is configured to snap onto and off of a protrusion, bulge, lump, nub, tab, or peg of the engaging portion of the mobile device or mobile device case.

7. The holder for a stylus according to claim 1, further comprising:
a second attachment feature configured to removably mate or connect with a corresponding attachment feature of a mobile device or a mobile device case.

8. The holder for a stylus according to claim 1;
wherein the first attachment feature is an engaging feature configured to engage with and be retained by a retaining portion of the mobile device or mobile device case to removably connect the holder z to the mobile device or mobile device case.

9. The holder for a stylus according to claim 7;
wherein the second attachment feature is an engaging feature configured to engage with and be retained by a retaining portion of the mobile device or mobile device case to removably connect the holder to the mobile device or mobile device case.

10. The holder for a stylus according to claim 8;
wherein the engaging feature comprises a protrusion, bulge, lump, nub, tab, or peg.

11. The holder for a stylus according to clam 8;
wherein the engaging feature is configured to snap into and out of the retaining portion of the mobile device or mobile device case.

12. The holder for a stylus according to claim 11;
wherein the engaging feature is configured to snap into and out of a groove, channel, recess, indentation, or hole of the retaining portion of the mobile device or mobile device case.

13. The holder for a stylus according to claim 1;
wherein the holder is manufactured as a single piece made from a single material or material mixture or combination.

14. The holder for a stylus according to claim 1;
wherein the holder is made from at least one material selected from the group consisting of an elastomeric material, rubber, silicone, thermoplastic elastomers (“TPEs”), thermoplastic polyurethane (“TPU”), polyolefins, polypropylene, polycarbonate, polyvinyl chloride acetate (“PVCA”), a similar plastic, and any combination thereof.

15. The holder for a stylus according to claim 1;
wherein the cap portion is configured to cover 25% to 100% of the cap end of the stylus when in the holder.

16. The holder for a stylus according to claim 1;
wherein the holder has a thickness dimension D_{T}, measured as a wall thickness of the body of 1.0 to 5.5 mm.

17. The holder for a stylus according to claim 1;
wherein the holder configured to cover at least 50% of the surface area of the stylus when arranged in the holder.
